(19) United States
(12) Patent Application Publication
(10) Pub. No.: US 2025/0289372 A1
(43) Pub. Date: Sep. 18, 2025

(54) VEHICLE INTERIOR COMPONENT

(71) Applicant: TOYODA GOSEI CO., LTD., Kiyosu-shi (JP)

(72) Inventors: Yuya SHIMIZU, Kiyosu-shi (JP); Yu HISHIDA, Kiyosu-shi (JP); Naoyuki FUKUI, Kiyosu-shi (JP); Takuto KAMAYA, Kiyosu-shi (JP); Yuya INAGAKI, Kariya-shi (JP)

(21) Appl. No.: 19/066,963

(22) Filed: Feb. 28, 2025

(30) Foreign Application Priority Data
Mar. 18, 2024 (JP) 2024-042447

(51) Int. Cl. B60R 7/04; B65D 5/66

(52) U.S. Cl. CPC B60R 7/04; B65D 5/66; B65D 2203/12

(57) ABSTRACT

A vehicle interior component includes a box body including an accommodation portion having an opening, a lid movably coupled to the box body and configured to close the opening by engaging with the box body, and a lock mechanism configured to lock the lid to a state in which the lid is engaged with the box body and unlock in accordance with an unlocking operation, and an indication mode changer configured to change an indication mode of the indication mode changer between when the lid is engaged with the box body and when the lid is disengaged from the box body.

### CROSS-REFERENCE TO RELATED APPLICATIONS

This application is based upon and claims the benefit of priority from Japanese Patent Application No. 2024-042447, filed on Mar. 18, 2024, the entire contents of which are incorporated herein by reference.

### BACKGROUND

### 1. Field

The following description relates to a vehicle interior component.

### 2. Description of Related Art

Japanese Laid-Open Patent Publication No. 2020-192957 discloses an example of a vehicle interior component that includes a box body, a lid, and a lock mechanism. The box body includes an accommodation portion provided with an opening. The lid is movably coupled to the box body. In the vehicle interior component, when the lid is engaged with the box body, the opening is closed. In this state, the lock mechanism locks the lid in a state in which the lid is engaged with the box body. The lid is held in place, keeping the opening closed. When an object is in the accommodation portion, the object is kept in the accommodation portion.

When an unlocking operation is performed on the lock mechanism, the lid is unlocked. As a result, the lid is disengaged from the box body and allows the opening to be uncovered. Through the uncovered opening, an object may be put into and taken out from the accommodation portion.

When the lid is disengaged from the box body, the lid is not locked by the lock mechanism even when, for example, the lid is located proximate to the position where the lid is engaged with the box body. In this state, the lid is movably coupled to the box body. If the lid receives a load from the environment, the lid may be separated from the box body by the load.

If an occupant of the vehicle notices that the lid is not locked by the lock mechanism, the occupant may engage the lid with the box body to lock the lid. However, the conventional vehicle interior component described above does not have a function to notify the occupant whether the lid is locked by the lock mechanism.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect of the present disclosure, a vehicle interior component includes a box body including an accommodation portion having an opening, a lid movably coupled to the box body and configured to close the opening by engaging with the box body, a lock mechanism configured to lock the lid to a state in which the lid is engaged with the box body and unlock the lid in accordance with an unlocking operation. The vehicle interior component further includes an indication mode changer configured to change an indication mode of the indication mode changer between when the lid is engaged with the box body and when the lid is disengaged from the box body.

Other features and aspects will be apparent from the following detailed description, the drawings, and the claims.

### BRIEF DESCRIPTION OF THE DRAWINGS

FIG. 1 is a perspective partial view of a first embodiment of a console box, which is a vehicle interior component.

FIG. 2 is a plan view of a lid and indication mode changers disposed at opposite sides of the lid in a front-rear direction, which are clipped from the console box shown in FIG. 1.

FIG. 3 is a perspective partial view of the console box shown in FIG. 1 with the lid engaged with a box body as viewed obliquely from the rear upper side.

FIG. 4 is a perspective partial view of the console box shown in FIG. 1 with the lid engaged with the box body as viewed obliquely from the front lower side.

FIG. 5 is a perspective view of a support of the console box shown in FIG. 1 as viewed obliquely from the front upper side.

FIG. 6 is an exploded perspective view of a portion of the support shown in FIG. 5 in a state an upthrust mechanism and the indication mode changer are not coupled to a support wall of the support.

FIG. 7 is a perspective view of a striker of the upthrust mechanism shown in FIG. 6 as viewed obliquely from the front upper side.

FIG. 8 is a cross-sectional view taken along line 8-8 in FIG. 2.

FIG. 9 is a cross-sectional view taken along line 9-9 in FIG. 2.

FIG. 10 is a cross-sectional partial view of the indication mode changer shown in FIG. 2 with the lid engaged with the box body.

FIG. 11 is a perspective partial view of the console box shown in FIG. 1 when the lid is disengaged from the box body as viewed obliquely from the front upper side.

FIG. 12 is a cross-sectional partial view of the console box when the lid in the state shown in FIG. 8 is forced upward by the upthrust mechanism and is disengaged from the box body.

FIG. 13 is a cross-sectional partial view of the console box when the lid is forced upward and the indication mode of the indication mode changer is changed from the state shown in FIG. 9.

FIG. 14 is a cross-sectional partial view of the indication mode changer shown in FIG. 2 with the lid disengaged from the box body.

FIG. 15 is a front partial view of a second embodiment of a console box showing an indication mode changer and its surroundings when the lid is disengaged from the box body.

FIG. 16 is a cross-sectional partial view of the console box shown in FIG. 15 showing the indication mode changer and its surroundings when the lid is engaged with the box body.

FIG. 17 is a cross-sectional partial view of the console box shown in FIG. 15 showing the indication mode changer and its surroundings when the lid is disengaged from the box body.

FIG. 18 is a perspective partial view of the console box shown in FIG. 15 showing the indication mode changer and its surroundings when the lid is disengaged from the box body.

FIG. 19 is a diagram showing an indication mode changer in a third embodiment of a console box.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

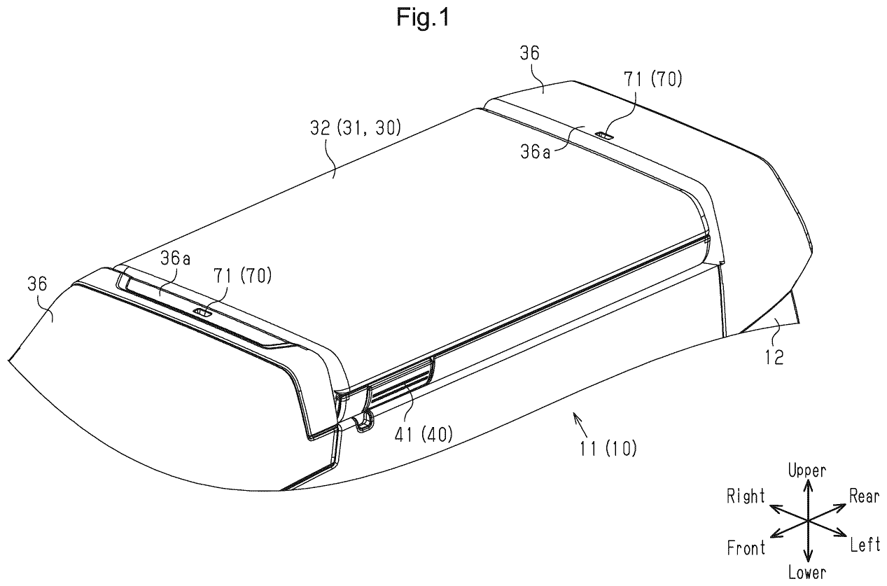

A vehicle interior component according to the present disclosure is embodied in a console box. A first embodiment of the console box will now be described with reference to FIGS. 1 to 14.

In the description hereafter, the front direction will correspond to the forward direction of a vehicle, and the rear direction will correspond to the rearward direction of the vehicle. The vertical direction conforms to the up-down direction of the vehicle, and the left-right direction conforms to a vehicle-width direction that conforms to the left-right direction when the vehicle is traveling forward.

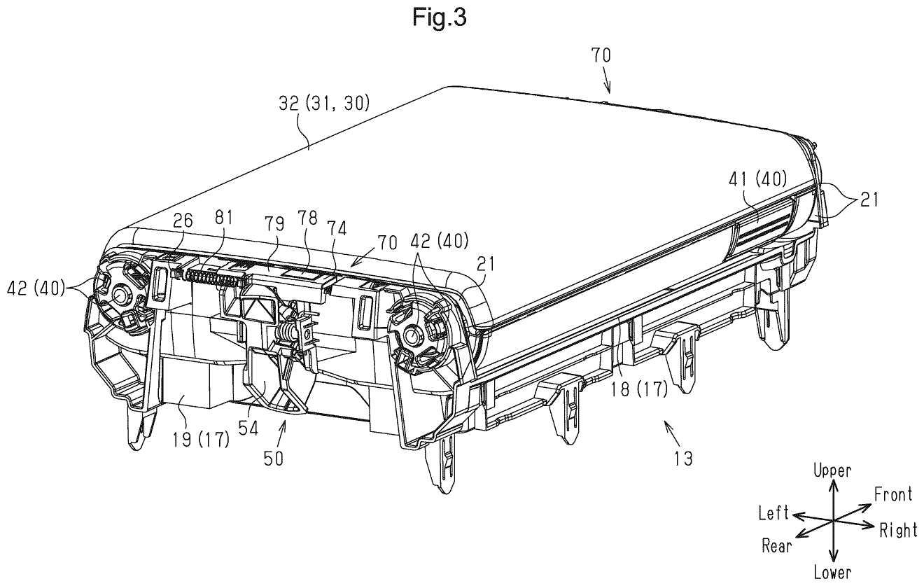

FIG. 1 shows the main section of a console box 10. The console box 10 is a part of a center console disposed between a driver seat and a passenger seat in a passenger compartment. The console box 10 includes a box body 11, a lid 30, two lock mechanisms 40 (refer to FIG. 3), two upthrust mechanisms 50 (refer to FIG. 8), and two indication mode changers 70. Components of the console box 10 will each be described below.

### Box Body 11

As shown in FIGS. 1, 8, and 12, the box body 11 includes a box unit 12 having an open upper end and a closed end, a support 13 disposed on an upper side of the box unit 12, and a panel 36 disposed around the support 13. The box unit 12 has the form of a rectangular box that is longer in the front-rear direction than in the left-right direction.

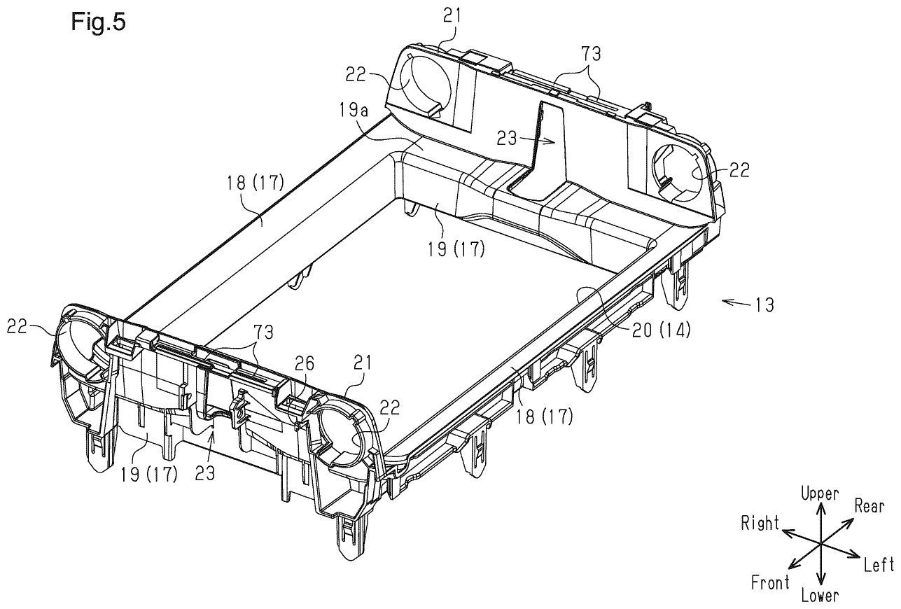

As shown in FIGS. 5, 8, and 12, the box unit 12 includes an accommodation portion 20 configured to accommodates an article such as a small object. The support 13 has a lower part including a rectangular frame 17. The accommodation portion 20 includes a space surrounded by the frame 17 and an internal space of the box unit 12. In the accommodation portion 20, an upper end of the space surrounded by the frame 17 defines an upper opening 14, or the opening of the accommodation portion 20. The upper opening 14 is open upward.

The frame 17 includes two first walls 18 extending in the front-rear direction and two second walls 19 extending in the left-right direction. The two first walls 18 extend parallel to each other and are spaced apart from each other in the left-right direction. The two second walls 19 extend parallel to each other and are spaced apart from each other in the front-rear direction.

A support wall 21 is disposed on the upper end of each second wall 19. The support wall 21 projects upward from an outer edge, in the front-rear direction, of the upper end. The support wall 21 includes opposite ends, in the left-right direction, each provided with a shim receptacle 22. Each shim receptacle 22 extends in the front-rear direction and has the form of a tube having two open ends.

The panel 36 covers the region surrounding the support 13 except the region between the support walls 21.

### Lid 30

As shown in FIGS. 1 to 3, the lid 30 is movably coupled to the box body 11. The lid 30 is also configured to pivot relative to the box body 11 between a closed position at which the upper opening 14 of the accommodation portion 20 is closed by the lid 30 as shown in FIG. 8, and a fully-open position (not shown) at which the lid 30 is upright and fully opens the upper opening 14. In other words, the lid 30 pivots between the closed position and the fully-open position to open and close the upper opening 14. In the description hereafter, the lid 30 is in a state in which the upper opening 14 is closed by the lid 30.

In the closed position, the lid 30 is engaged with the box body 11. The phrase “engaged with” refers to a state in which the lid 30 is entirely located between the two support walls 21.

### Basic Structure of Lid 30

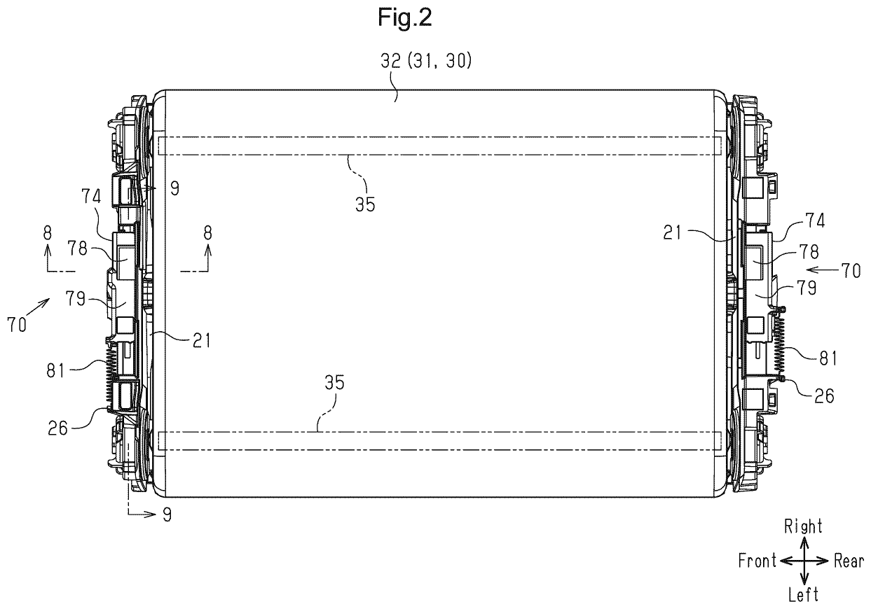

As shown in FIGS. 2, 8, and 11, the lid 30 includes a lid body 31, two support plates 34, and two pivot shafts 35. The lid body 31 is shaped and sized to occupy the region between the support walls 21. The thickness-wise direction of the lid body 31 conforms to the vertical direction.

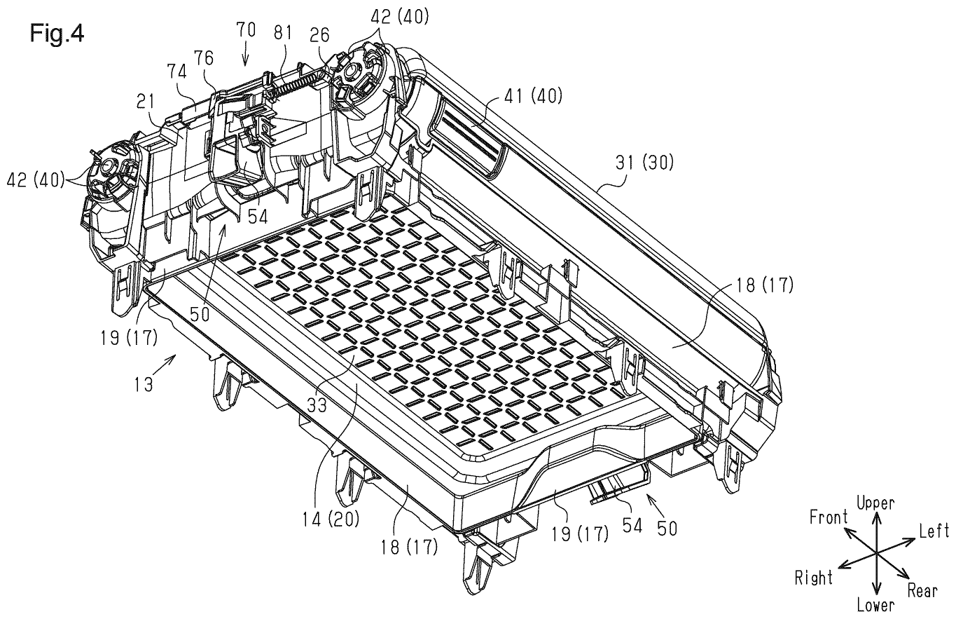

The lid 30 includes a first surface 32 and a second surface 33 (refer to FIG. 4) located on opposite sides in the vertical direction. The first surface 32 includes at least partially an armrest surface. The second surface 33 includes a tray surface.

The two support plates 34 are disposed on opposite ends of the lid body 31 in the front-rear direction. The two support plates 34 are coupled to the lid body 31. The two support plates 34 each include an outer surface, in the front-rear direction, forming a part of a peripheral surface of the lid 30.

The lid 30 is shaped such that the lid 30 may be coupled to and separated from the support 13 regardless of whether the first surface 32 or the second surface 33 is oriented upward.

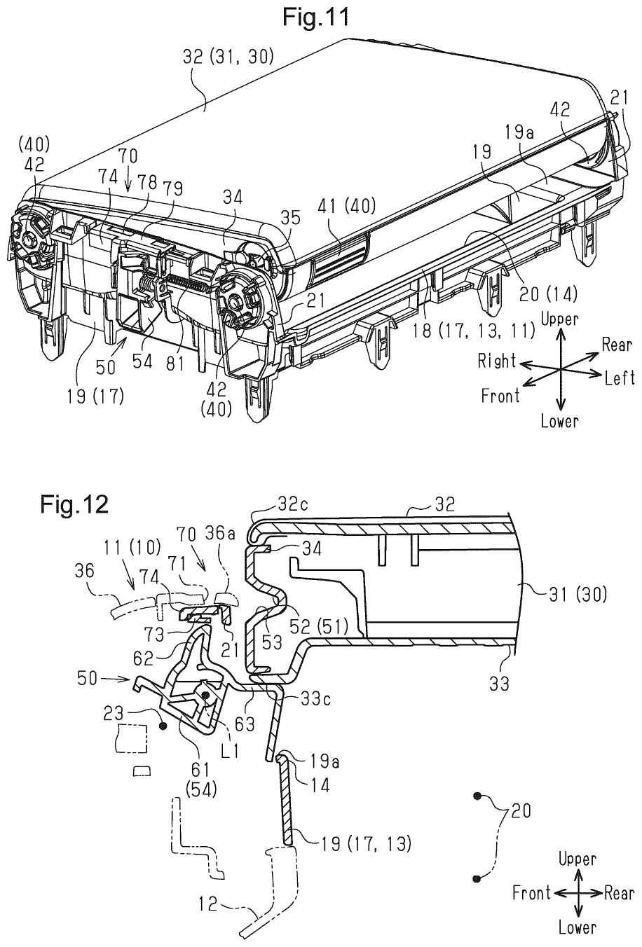

As shown in FIGS. 2 and 11, the two pivot shafts 35 pivotally couple the lid body 31 to the box body 11. The two pivot shafts 35 are disposed at opposite ends of the lid body 31 in the left-right direction and extend parallel to each other in the front-rear direction. The pivot shafts 35 are slidable in the left-right direction while maintaining the position so that the pivot shafts 35 extend in the front-rear direction.

The lid 30 is configured to pivot between the closed position and the fully-open position about a selected one of the two pivot shafts 35.

### Lock Mechanism 40

As shown in FIGS. 2 to 4, the two lock mechanisms 40 are disposed on opposite ends of the console box 10 in the left-right direction. Each lock mechanism 40 locks the lid 30 in a state in which the lid 30 is engaged with the box body 11, that is, the upper opening 14 is closed by the lid 30 (closed position). When an unlocking operation is performed, the lock mechanism 40 unlocks the lid 30. The two lock mechanisms 40 have a structure symmetrical with respect to the left-right direction.

As shown in FIGS. 3 and 4, the lock mechanisms 40 each include an operating portion 41 and a shim 42. The operating portion 41 is disposed at a side surface of the lid 30 in the left-right direction. The operating portion 41 is located toward a front part of the lid 30. The operating portion 41 is movable in the left-right direction. Hereafter, an operation for moving the operating portion 41 inward in the left-right direction is referred to as the “depressing operation.” The operating portions 41 of the two lock mechanisms 40 are independent of each other. Each of the two pivot shafts 35 is supported by the corresponding one of the operating portions 41 so as to pivot about the axis.

As shown in FIGS. 4 and 5, the shims 42 are respectively accommodated in the shim receptacles 22 of the support wall 21. Each shim 42 is coupled to the support wall 21 so as to be movable in the front-rear direction while rotation of the shim 42 is restricted. The shim 42 detachably couples an end of the pivot shaft 35 in the front-rear direction to the box body 11. Also, the shim 42 pivotally supports the pivot shaft 35 while coupling the end of the pivot shaft 35 to the box body 11.

When the lid 30 is engaged with the box body 11 and the depressing operation is not performed on either of the two operating portions 41, the outer part of each operating portion 41 in the left-right direction projects from the lid 30. In this state, the pivot shafts 35 are coupled to the support wall 21 by the shims 42. Thus, the lid 30 is locked to a state in which the lid 30 is engaged with the box body 11 so that the upper opening 14 is held in the closed state.

When the depressing operation is performed on one of the two operating portions 41, the corresponding one of the pivot shafts 35 moves inward in the left-right direction while rotating. The shim 42 supporting the pivot shaft 35 is pushed by the pivot shaft 35 to move outward in the front-rear direction. In this case, the shim 42 moves in a direction in which the shim 42 moves away from the pivot shaft 35.

When the pivot shaft 35 is separated from the shim 42, the pivot shaft 35 is uncoupled from the support wall 21. That is, the lid 30 is unlocked. The pivot shaft 35 corresponding to the operating portion 41 that is free of the depressing operation remains coupled to the support wall 21.

The lid 30 is inclined upward from a horizontal plane toward the operated one of the operating portions 41 in the left-right direction.

When the depressing operation is simultaneously performed on the two independent operating portions 41, that is, the unlocking operation is simultaneously performed on the lock mechanisms 40, the two pivot shafts 35 move in the same manner as when the depressing operation is performed on one of the operating portions 41 as described above.

When the pivot shafts 35 are separated from the shims 42, the two pivot shafts 35 are uncoupled from the box body 11. That is, the lid 30 is unlocked.

### Upthrust Mechanism 50

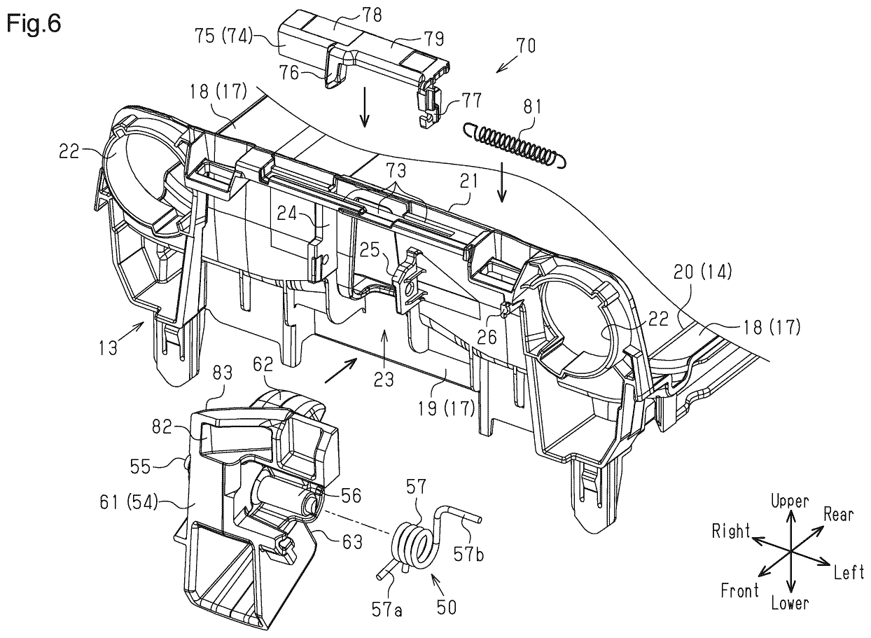

As shown in FIGS. 4 and 6, when the depressing operation is performed on the operating portion 41, the upthrust mechanism 50 forces the lid 30 upward from the box body 11. In the console box 10 of the first embodiment, the two upthrust mechanisms 50 are arranged on opposite side portions of the support 13 in the front-rear direction. More specifically, the two upthrust mechanisms 50 are arranged at a central portion of the support 13 in the left-right direction.

The two upthrust mechanisms 50 have a structure symmetrical with respect to the front-rear direction. As shown in FIGS. 6 to 8, each upthrust mechanism 50 includes a recess 51 arranged in the lid 30, a striker 54, and a first spring 57, which is a first urging member.

As shown in FIG. 8, the recess 51 is arranged in the peripheral surface of the lid 30 in the front-rear direction. More specifically, the recess 51 is formed in the outer surface of the support plate 34 in the front-rear direction. The recess 51 is formed in a central portion of the support plate 34 in the thickness-wise direction of the lid 30. The recess 51 is open in the outer surface of the support plate 34 in the front-rear direction.

The lid 30 includes first pushed-up portions 52 and 53. The first pushed-up portions 52 and 53 are defined by two wall surfaces of the recess 51 facing each other in the thickness-wise direction. The lid 30 further includes second pushed-up portions 32c and 33c. The second pushed-up portion 32c is defined by a central part, in the left-right direction, of the outer edge of the first surface 32 in the front-rear direction. In the same manner, the second pushed-up portion 33c is defined by a central part, in the left-right direction, of the outer edge of the second surface 33 in the front-rear direction.

As shown in FIGS. 5 and 6, the support walls 21 each include a central part, in the left-right direction, provided with a striker receptacle 23 having a slot. The slot extends over from the support wall 21 to a portion of the upper end of the second wall 19 located at an inner side of the support wall 21 in the front-rear direction.

As shown in FIG. 6, the striker receptacle 23 includes a first vertical wall 24 and a second vertical wall 25. The first vertical wall 24 and the second vertical wall 25 are spaced apart from each other in the left-right direction and extend in the vertical direction and the front-rear direction. The striker receptacle 23 is open outward in the front-rear direction.

As shown in FIGS. 4, 6, and 9, the striker 54 is accommodated in the striker receptacle 23. The striker 54 includes opposite surfaces in the left-right direction including shafts 55 and 56 extending away from each other in the left-right direction. The shaft 55 is inserted through the first vertical wall 24. The shaft 56 is inserted through the second vertical wall 25. The shafts 55 and 56 rotatably support the striker 54 on the support wall 21 and the second wall 19 via the first vertical wall 24 and the second vertical wall 25.

The first spring 57 is coupled between the striker 54 and the support wall 21 so that the following condition is satisfied. In the first embodiment, the first spring 57 is a torsion spring.

The condition is that the first spring 57 urges the striker 54 in a pivoting direction in which the lid 30 is forced upward. In pivoting directions of the striker 54 about the shafts 55 and 56, the direction in which the striker 54 forces the lid 30 upward is referred to as the “urging pivoting direction.” In the first embodiment, a large portion of the first spring 57 is arranged around the shaft 56 of the striker 54. The first spring 57 includes one end 57a hooked on the striker 54 at a position separated radially outward from the shaft 56. The first spring 57 includes another end 57b hooked on the support wall 21, more specifically, on the second vertical wall 25 at a position separated radially outward from the shaft 56.

As shown in FIGS. 6 to 8, the striker 54 includes a body 61, a first upthrust portion 62, and a second upthrust portion 63. The body 61 forms the framework of the striker 54.

The shafts 55 and 56 are arranged on the body 61. The first upthrust portion 62 is a protrusion projecting outward from the body 61 in the radial direction of the shafts 55 and 56. The second upthrust portion 63 is separated from the first upthrust portion 62 to the trailing side in the urging pivoting direction. The second upthrust portion 63 is a protrusion projecting from the body 61 outward in the radial direction. When the lid 30 is engaged with the box body 11 (i.e., the upper opening 14 is closed), the first upthrust portion 62 is received in the recess 51. As the lid 30 is moved upward from a state where the lid 30 is engaged with the box body 11, the first upthrust portion 62 withdraws from the recess 51. When the first upthrust portion 62 is received in the recess 51, the first upthrust portion 62 applies upthrust force to the first pushed-up portion 52.

As described above, when the lid 30 is engaged with the box body 11, the second upthrust portion 63 is separated from the lid 30 so that at least part of the second upthrust portion 63 is located below the lower surface of the lid 30, more specifically, below the lower one of the second pushed-up portions 32c and 33c. After the upthrust of the first upthrust portion 62, the second upthrust portion 63 comes into contact with and applies upthrust force to the lower one of the second pushed-up portions 32c and 33c (refer to FIG. 12).

### Indication Mode Changer 70

The indication mode changer 70 includes an indication mode that changes between when the lid 30 is engaged with the box body 11 as shown in FIG. 3 and when the lid 30 is disengaged from the box body 11 as shown in FIG. 11. More specifically, the indication mode changer 70 includes a part that can be seen by an occupant and changes the indication mode of the part between when the lid 30 is engaged with the box body 11 and when the lid 30 is disengaged from the box body 11. The two indication mode changers 70 are located on the opposite side portions of the support 13 in the front-rear direction. The two indication mode changers 70 have a structure symmetrical with respect to the front-rear direction.

As shown in FIGS. 1, 8, and 9, each indication mode changer 70 includes a window 71 arranged on an upper portion of the panel 36. The window 71 corresponds to a light-transmissive window. The two windows 71 are formed on the upper portion of the panel 36 and spaced apart from each other in the front-rear direction. More specifically, the positions of the two windows 71 on the panel 36 in the front-rear direction are adjacent to opposite sides of the upper opening 14 in the front-rear direction, more specifically, above the support walls 21. The positions of the windows 71 on the panel 36 in the left-right direction are a central area of the panel 36 or the vicinity of the central area.

The window 71 is a hole extending through the panel 36 in the thickness-wise direction of the box body 11, that is, the vertical direction. In other words, the window 71 extends through in a direction in which the upper opening 14 is open (upward direction). In the first embodiment, the window 71 is rectangular. However, the window 71 may have another shape. The window 71 is transmissive to visible light. The window 71 is a part of the indication mode changer 70.

The panel 36 includes an ornamental surface 36a located at one side, which is defined as an outer side. The side of the panel 36 opposite from the ornamental surface 36a is defined as an inner side. As described above, the panel 36 is a member forming a part of the box body 11. The ornamental surface 36a of the panel 36 forms a part of the ornamental surface of the box body 11.

In the indication mode changer 70 of the first embodiment, the indication mode of the window 71 is changed by a member located at the inner side (lower side) of the window 71.

As shown in FIGS. 2 and 6, the indication mode changer 70 further includes a first moving member 74. The first moving member 74 is arranged at a position lower than the window 71. The first moving member 74 is movable in an intersecting direction that intersects the vertical direction. In other words, the first moving member 74 is movable in a direction that intersects the direction (upward direction) in which the upper opening 14 is open. In the first embodiment, the intersecting direction conforms to the left-right direction.

More specifically, each support wall 21 includes a guide 73 extending in the left-right direction. The guide 73 projects outward from an outer surface, in the front-rear direction, of the support wall 21. The guide 73 is arranged between the two shim receptacles 22 of the support wall 21. The guide 73 is arranged between the striker receptacle 23 and the window 71.

The first moving member 74 includes a main plate 75 forming the framework of the first moving member 74. The main plate 75 is arranged on the guide 73. The main plate 75 is elongated with dimensions greater in the left-right direction than in the front-rear direction. The thickness-wise direction of the main plate 75 conforms to the vertical direction. When the first moving member 74 is coupled to the guide 73, the first moving member 74 is slidable on the guide 73 in the left-right direction while movement of the first moving member 74 is restricted in the front-rear direction and the vertical direction.

As shown in FIGS. 6, 9, and 10, the first moving member 74 is a pressure-receiving portion 76 and a spring hook 77. The pressure-receiving portion 76 projects downward from an intermediate portion of the main plate 75 in the left-right direction. The spring hook 77 projects downward from one end (left end) of the main plate 75 in the left-right direction.

The main plate 75 includes an upper surface including a first indicator 78 and a second indicator 79 that differ from each other in at least one of color and pattern. The first indicator 78 and the second indicator 79 are arranged next to each other in the left-right direction. In the first embodiment, the first indicator 78 is colored adhesive tape. The first indicator 78 is applied to a portion of the upper surface of the main plate 75 in the left-right direction. The second indicator 79 is formed of a portion of the upper surface of the main plate 75 that differs from the portion to which the first indicator 78 is applied.

The support wall 21 includes a spring hook 26. The spring hook 26 is arranged between the striker receptacle 23 and one (left one) of the two shim receptacles 22. In the first embodiment, the spring hook 26 is arranged in proximity to one (left one) of the shim receptacles 22.

A spring 81, which is an urging member, is arranged between the first moving member 74 and the support wall 21. In the first embodiment, the spring 81 is an extension coil spring. One end (right end) of the spring 81 is hooked on the spring hook 77 of the first moving member 74. The other end (left end) of the spring 81 is hooked on the spring hook 26 of the support wall 21. The spring 81 is tensioned in the left-right direction and hooked on the spring hooks 77 and 26. The spring 81 constantly applies a leftward urging force (pulling force) to the first moving member 74.

The indication mode changer 70 uses an action of the upthrust mechanism 50 upwardly forcing the lid 30, which is described above, as a force that moves the first moving member 74 in the left-right direction.

More specifically, as shown in FIGS. 6, 7, and 10, the indication mode changer 70 includes a conversion transmitter 82 arranged on the striker 54. The conversion transmitter 82 converts pivot movement of the striker 54 about the shafts 55 and 56 to linear movement of the first moving member 74 in the left-right direction via the pressure-receiving portion 76.

The conversion transmitter 82 is arranged on the striker 54 at a position higher than the shafts 55 and 56 and the first upthrust portion 62. The conversion transmitter 82 is formed integrally with the body 61. The conversion transmitter 82 includes an inclined surface 83 inclined from an axis L1 of the shafts 55 and 56. The position of the inclined surface 83 that contacts the pressure-receiving portion 76 changes as the striker 54 pivots about the shafts 55 and 56. The conversion transmitter 82 applies a rightward pressing force, which is against the urging force (pulling force) of the spring 81, to the first moving member 74 via the inclined surface 83. Thus, the conversion transmitter 82 moves the first moving member 74 in the left-right direction.

The indication mode changer 70 moves the first moving member 74 in the left-right direction so that one of the first indicator 78 and the second indicator 79 located under the window 71 when the lid 30 is engaged with the box body 11 differs from the other one of the first indicator 78 and the second indicator 79 located under the window 71 when the lid 30 is disengaged from the box body 11.

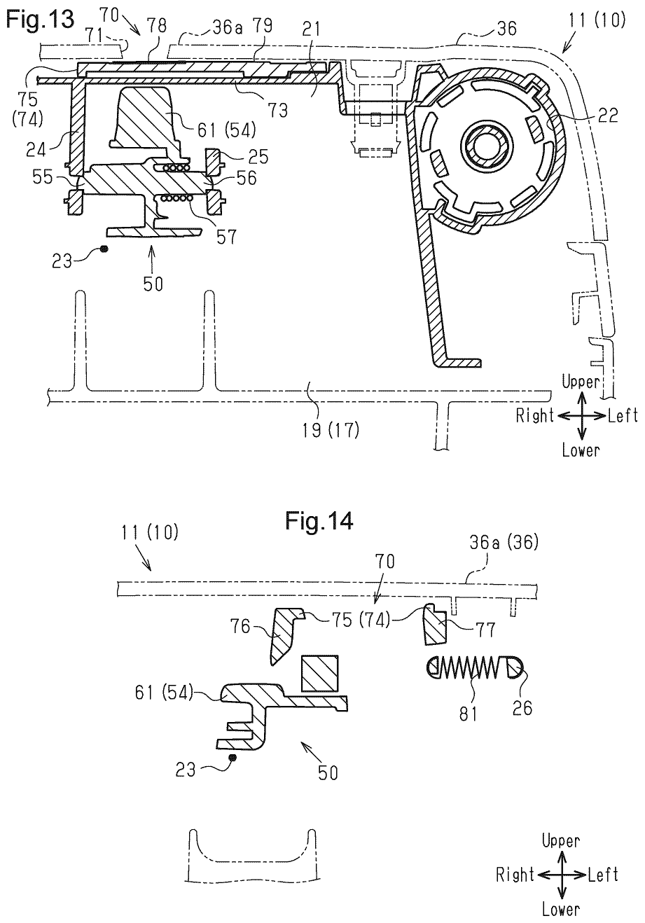

In the first embodiment, as shown in FIG. 9, when the lid 30 is engaged with the box body 11, the second indicator 79 is located under the window 71. As shown in FIG. 13, when the lid 30 is disengaged from the box body 11, the first indicator 78 is located under the window 71.

### Operation of First Embodiment

Lid 30 Engaged with Box Body 11

In this state, as shown in FIGS. 3 and 4, the lid 30 is located in the closed position. The depressing operation is not performed on any of the operating portions 41. The outer part of each operating portion 41 projects from the lid 30 in the left-right direction.

The pivot shafts 35 (refer to FIG. 2) are coupled to the support walls 21 by the shims 42. Therefore, the lid 30 is locked to a state in which the lid 30 is engaged with the box body 11 (closed position). The upper opening 14 is held in the closed state.

In this state, as shown in FIG. 8, a large part of the first upthrust portion 62 of the striker 54 is received in the recess 51 of the lid 30. The striker 54 is urged by the first spring 57 in the urging pivoting direction to upwardly force the lid 30. The first upthrust portion 62 is in contact with the first pushed-up portion 52 of the recess 51. Urging force of the first spring 57 is applied, as upthrust force, to the first pushed-up portion 52 via the first upthrust portion 62. Thus, the upthrust force of the two upthrust mechanisms 50 is applied to the lid 30 via the first upthrust portions 62.

In this state, the second upthrust portion 63 of the striker 54 is separate from the second pushed-up portion 33c of the lid 30. Hence, upthrust force is not applied from the second upthrust portion 63 to the second pushed-up portion 33c of the lid 30.

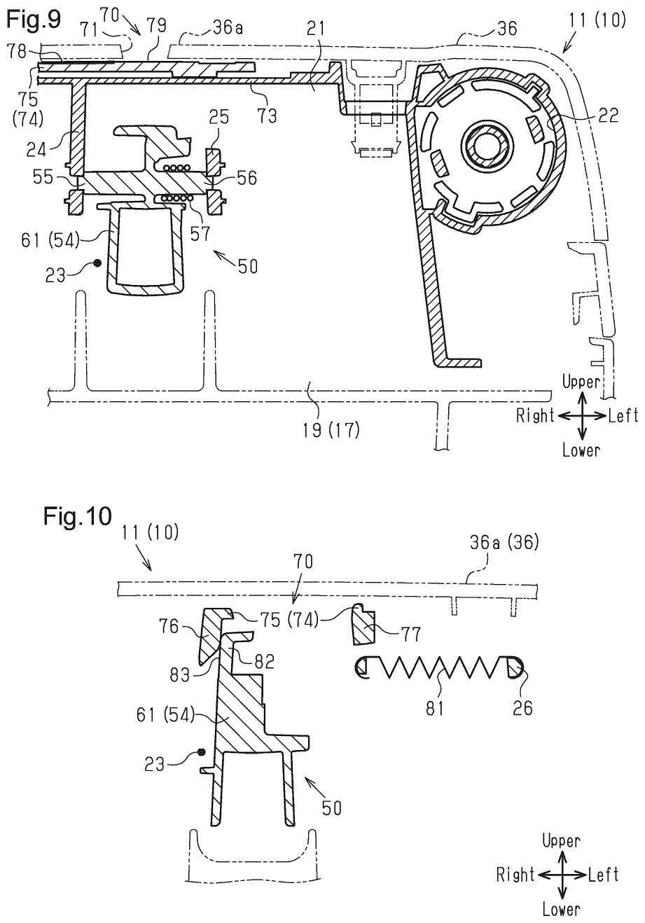

As shown in FIGS. 9 and 10, the indication mode changer 70 moves the first moving member 74 rightward by applying an action of the upthrust mechanism 50 upwardly forcing the lid 30. More specifically, the inclined surface 83 of the conversion transmitter 82 is in contact with the pressure-receiving portion 76 of the first moving member 74, which is pulled leftward by the spring 81. The inclined surface 83 of the conversion transmitter 82 applies rightward pressing force to the first moving member 74. When the lid 30 is engaged with the box body 11, a large part of the first upthrust portion 62 is received in the recess 51 (refer to FIG. 8). The pressing force applied from the inclined surface 83 to the first moving member 74 is relatively large. The first moving member 74 is located at a position where the pulling force of the spring 81 balances with the pressing force applied from the inclined surface 83. In the example shown in FIG. 10, the first moving member 74 is located at the right end of the movable range in the left-right direction. As a result, the second indicator 79 is located under the window 71. When the occupant sees the window 71, the second indicator 79 is shown through the window 71. In other words, the occupant sees the window 71 showing the second indicator 79.

The indication mode changer 70 uses a different indication mode of the window 71 between when the lid 30 is engaged with the box body 11 and when the lid 30 is disengaged from the box body 11 (refer to FIG. 13). However, the shape of the box body 11 is the same at an outer side of the window 71 when the lid 30 is engaged with the box body 11 and when the lid 30 is disengaged from the box body 11.

The indication mode of the window 71, which is changed by the indication mode changer 70, allows the occupant to recognize that the lid 30 is engaged with the box body 11 and the lock mechanism 40 locks the lid 30 to a state in which the lid 30 is engaged with the box body 11.

### Depressing Operation on One Operating Portion 41

As shown in FIG. 11, when the depressing operation is performed on one of the operating portions 41 (in FIG. 11, one located at the left), the pivot shaft 35 corresponding to the operating portion 41 moves inward in the left-right direction while rotating.

The shims 42 supporting the pivot shaft 35 are pushed by the pivot shaft 35 and moved outward in the front-rear direction. When the ends of the pivot shaft 35 are separated from the shims 42, the pivot shaft 35 is uncoupled from the support walls 21.

The pivot shaft 35 corresponding to the operating portion 41 (one located at the right) that is free of the depressing operation remains coupled to the support wall 21.

The upthrust force of the two upthrust mechanisms 50 is applied to the lid 30. As shown in FIG. 12, the striker 54 is urged by the first spring 57 to pivot in the urging pivoting direction (counterclockwise direction in FIG. 12) and upwardly force the lid 30. In accordance with the pivoting, the first upthrust portion 62 applies upthrust force to the first pushed-up portion 52 of the recess 51 to upwardly force the lid 30.

The lid 30 pivots upward about the pivot shaft 35 corresponding to the operating portion 41 that is free of the depressing operation.

In accordance with the pivoting of the striker 54 described above, the first upthrust portion 62 withdraws from the recess 51. The second upthrust portion 63 approaches the lower surface of the lid 30. In the illustrated example, the second upthrust portion 63 approaches the second pushed-up portion 33c of the second surface 33. Even after the first upthrust portion 62 withdraws from the recess 51 and completes the upward pushing, the striker 54 continues to pivot. The second upthrust portion 63 comes into contact the second pushed-up portion 33c of the lid 30, and the striker 54 applies upthrust force to the lid 30. The lid 30 is continuously forced upward by the upthrust force of the second upthrust portion 63.

As shown in FIGS. 11 and 12, the lid 30 is inclined so that the lid 30 is located at higher positions in the left-right direction toward the side (left side) where the operated one of the operating portions 41 is located. More specifically, the lid 30 is disengaged from the box body 11 but is close to engage the box body 11. In this state, the lid 30 is unlocked from the lock mechanism 40. The lid 30 is movably coupled to the box body 11. In this state, if the lid 30 receives a load from the environment, the lid 30 may be separated from the box body 11 by the load.

In this regard, in the first embodiment, as shown in FIGS. 13 and 14, the action of the upthrust mechanism 50 upwardly forcing the lid 30 is used as force that moves the first moving member 74 leftward. More specifically, in accordance with the pivoting of the striker 54 in the urging pivoting direction to upwardly force the lid 30, the inclined surface 83 also pivots in the urging pivoting direction. As the pivoting of the striker 54 in the urging pivoting direction advances, rightward pressing force applied by the inclined surface 83 to the pressure-receiving portion 76 decreases. As a result, the pulling force of the spring 81 moves the first moving member 74 leftward along the guide 73. Accordingly, the contact position of the conversion transmitter 82 with the pressure-receiving portion 76 of the inclined surface 83 changes. In accordance with the movement, the first indicator 78 moves toward a position under the window 71. When the occupant views the window 71, the first indicator 78 is shown through the window 71. In other words, the occupant sees the window 71 showing the first indicator 78.

The indication mode changer 70 uses a different indication of the window 71 between when the lid 30 is disengaged from the box body 11 and when the lid 30 is engaged with the box body 11 (refer to FIG. 9). However, the shape of the box body 11 is the same at an outer side of the window 71 when the lid 30 is disengaged from the box body 11 and when the lid 30 is engaged with the box body 11.

The indication mode of the window 71, which is changed by the indication mode changer 70, allows the occupant to recognize that the lid 30 is disengaged from the box body 11 and that the lid 30 is not locked by the lock mechanism 40 to a state in which the lid 30 is engaged with the box body 11.

The indication mode changer 70 allows the occupant to notice the following point.

If the state continues and the lid 30 receives a load from the environment, the lid 30 may be separated from the box body 11 by the load.

When the lid 30 is engaged with the box body 11, the lid 30 is locked to a state in which the lid 30 is engaged with the box body 11.

As shown in FIG. 11, when the occupant stops depressing the operating portion 41, the operating portion 41 is moved outward in the left-right direction with the corresponding one of the pivot shafts 35. In accordance with the movement, the outer part of the operating portion 41 in the left-right direction projects outward from the lid 30. In addition, in the support walls 21, the shims 42 corresponding to the pivot shaft 35 move inward in the front-rear direction.

When engaging the lid 30 with the box body 11, a downward pressing force is applied to the lid 30. As a result, the lid 30 pivots about the pivot shaft 35 corresponding to the operating portion 41 that is free of the depressing operation to close the upper opening 14. The pivot shaft 35 is coupled to the support walls 21 by the corresponding shims 42. As a result, the lid 30 is locked to a state in which the lid 30 is engaged with the box body 11. The upper opening 14 is held in the closed state.

As shown in FIG. 8, in each of the two upthrust mechanisms 50, in accordance with downward movement of the lid 30, the second pushed-up portion 33c of the second surface 33 first comes into contact with the second upthrust portion 63 of the striker 54. In accordance with the downward movement of the lid 30, the lid 30 applies depressing force, which is directed downward, to the second upthrust portion 63. The depressing force causes the striker 54 to pivot in a direction (clockwise direction in FIG. 8) opposite to the urging pivoting direction. In accordance with the pivoting, the first upthrust portion 62 enters the recess 51 as the first upthrust portion 62 is in contact with the first pushed-up portion 52. In addition, the second upthrust portion 63 moves downward away from the second pushed-up portion 33c. When the lid 30 is moved to the closed position, a large part of the first upthrust portion 62 is received in the recess 51. In this state, upthrust force of the upthrust mechanism 50 is applied to the lid 30 via the first upthrust portion 62.

As shown in FIGS. 9 and 10, in the indication mode changer 70, as the striker 54 pivots in the direction opposite to the urging pivoting direction, rightward pressing force applied by the inclined surface 83 to the pressure-receiving portion 76 increases. As a result, the first moving member 74 is moved rightward along the guide 73 against the pulling force of the spring 81. Accordingly, the contact position of the inclined surface 83 with the pressure-receiving portion 76 changes. In accordance with the movement, the second indicator 79 moves toward a position under the window 71. When the occupant sees the window 71, the second indicator 79 is shown through the window 71.

### Simultaneous Depressing Operation on Two Operating Portions 41

When the depressing operation is simultaneously performed on the two operating portions 41, the two pivot shafts 35 move in the same manner as described in the section of “Depressing Operation on One Operating Portion 41.”

The upthrust force of the two upthrust mechanisms 50 is applied to the lid 30. More specifically, as shown in FIG. 12, the striker 54 is urged by the first spring 57 to pivot in the urging pivoting direction (counterclockwise direction in FIG. 12) and upwardly force the lid 30. In accordance with the pivoting, the first upthrust portion 62 applies upthrust force to the first pushed-up portion 52 of the recess 51 to upwardly force the lid 30.

In this case, in accordance with the pivoting of the striker 54 described above, the first upthrust portion 62 withdraws from the recess 51, and the second upthrust portion 63 approaches the second pushed-up portion 33c of the lid 30. Even after the first upthrust portion 62 completes the upward pushing, the striker 54 continues to pivot, and the second upthrust portion 63 comes into contact with and applies upthrust force to the second pushed-up portion 33c of the lid 30. The lid 30 is continuously forced upward by the upthrust force of the second upthrust portion 63. Although not shown, the lid 30 results in a state in which the upper part of the lid 30 projects upward from the box body 11. This allows the lid 30 to be removed from the box body 11.

When the occupant stops depressing the operating portions 41, in the lid 30, each operating portion 41 is moved with the pivot shaft 35 outward in the left-right direction. The outer part of the operating portion 41 in the left-right direction projects outward in the left-right direction from the lid 30.

In addition, in the support walls 21, the shims 42 corresponding to the pivot shaft 35 move inward in the front-rear direction.

In this case, the indication mode changer 70 operates in the same manner as described in the section of “Depressing Operation on One Operating Portion 41.” More specifically, as the striker 54 pivots about the shafts 55 and 56, rightward pressing force applied from the inclined surface 83 to the pressure-receiving portion 76 decreases. As a result, the pulling force of the spring 81 moves the first moving member 74 leftward along the guide 73. Accordingly, the contact position of the inclined surface 83 with the pressure-receiving portion 76 changes. In accordance with the movement, the first indicator 78 moves toward a position under the window 71. When the occupant sees the window 71, the first indicator 78 is shown through the window 71.

### Coupling of Lid 30 to Box Body 11

To couple the lid 30 to the box body 11 with the first surface 32 and the second surface 33 inverted upside down, the lid 30 is pressed on the box body 11 from above. As a result, each pivot shaft 35 is coupled to the support walls 21 by the corresponding the shims 42. Therefore, the lid 30 is locked to a state in which the lid 30 is engaged with the box body 11 (closed position). The upper opening 14 is held in the closed state.

In this case, the two upthrust mechanisms 50 reversely perform the operation described in the section of “Simultaneous Depressing Operation on Two Operating Portions 41.” As the lid 30 moves downward, the second pushed-up portion 32c of the first surface 32 first comes into contact with the second upthrust portion 63 of the striker 54. As the lid 30 moves downward, the lid 30 applies depressing force, which is directed downward, to the second upthrust portion 63 of the striker 54. The depressing force causes the striker 54 to pivot in a direction opposite to the urging pivoting direction. In accordance with the pivoting, the first upthrust portion 62 enters the recess 51 as the first upthrust portion 62 is in contact with the first pushed-up portion 53. In addition, the second upthrust portion 63 moves downward away from the second pushed-up portion 32c of the lid 30. When the lid 30 is moved to the closed position, a large part of the first upthrust portion 62 is received in the recess 51. In this state, upthrust force of the upthrust mechanism 50 is applied to the lid 30 through the first upthrust portion 62.

As a result, the lid 30 is engaged with the box body 11.

As shown in FIGS. 9 and 10, in the indication mode changer 70, as the striker 54 pivots in the direction opposite to the urging pivoting direction, rightward pressing force applied by the inclined surface 83 to the pressure-receiving portion 76 increases. As a result, the first moving member 74 is moved rightward along the guide 73 against the pulling force of the spring 81. Accordingly, the contact position of the inclined surface 83 with the pressure-receiving portion 76 changes. In accordance with the movement, the second indicator 79 moves toward a position under the window 71. When the occupant sees the window 71, the second indicator 79 is shown through the window 71.

### Advantages of First Embodiment

(1-1) The console box 10 includes the indication mode changer 70 having the indication mode that changes between when the lid 30 is engaged with the box body 11 (refer to FIG. 9) and when the lid 30 is disengaged from the box body 11 (refer to FIG. 13).

When an occupant of the vehicle sees the indication mode of the indication mode changer 70, the occupant may recognize whether the lid 30 is engaged with the box body 11 or not. When the lid 30 is disengaged, the occupant may recognize that the lid 30 is not locked by the lock mechanisms 40. Then, the occupant may engage the lid 30 with the box body 11 to lock the lid 30 to a state in which the lid 30 is engaged with the box body 11. In this state, even when the lid 30 receives a load from the environment, separation of the lid 30 from the box body 11 is avoided. That is, the lid 30 is less likely to be separated from the box body 11.

(1-2) The panel 36 of the box body 11 includes the window 71 that allows transmission of visible light. In the indication mode changer 70, the member (first moving member 74) arranged at the inner side (lower side) of the window 71 is used to change the indication mode of the window 71.

Thus, when an occupant sees the indication mode of the indication mode changer 70 through the window 71, the occupant may recognize whether the lid 30 is engaged with the box body 11 or not. With this structure, the outer shape of the box body 11 is likely to remain the same when the indication mode of the window 71 changes. In other words, the engagement state of the lid 30 with the box body 11 can be recognized without changing the outer shape of the box body 11.

(1-3) The indication mode changer 70 includes the first moving member 74 arranged at the inner side (lower side) of the window 71 and configured to move in the left-right direction. The outer (upper) surface of the first moving member 74 is provided with the first indicator 78 and the second indicator 79 that differ from each other in at least one of color and pattern. The first indicator 78 and the second indicator 79 are arranged next to each other in the left-right direction. The indication mode changer 70 moves the first moving member 74 so that one of the first indicator 78 and the second indicator 79 located inside (under) the window 71 when the lid 30 is engaged with the box body 11 differs from the other one of the first indicator 78 and the second indicator 79 located inside (under) the window 71 when the lid 30 is disengaged from the box body 11.

When the first moving member 74 is moved in the left-right direction, the first indicator 78 and the second indicator 79, which are arranged on the outer surface of the first moving member 74, also move in the left-right direction. The occupant sees one of the first indicator 78 and the second indicator 79 that is located inside (under) the window 71 to recognize whether the lid 30 is engaged with the box body 11 or not.

(1-4) The console box 10 includes the upthrust mechanisms 50 that upwardly force the lid 30 from the box body 11 when the lid 30 is unlocked. Thus, when the lid 30 is unlocked, the lid 30 is forced upward from the box body 11 by the upthrust mechanisms 50. The upward force results in projection of a portion of the lid 30 from the box body 11. This disengages the lid 30 from the box body 11.

The indication mode changer 70 moves the first moving member 74 in the left-right direction by applying the action of the upthrust mechanisms 50 upwardly forcing the lid 30. This eliminates the need for a separate mechanism that moves the first moving member 74.

(1-5) As shown in FIGS. 6 and 8, the upthrust mechanism 50 includes the striker 54, the first spring 57, and the recess 51 formed in the lid 30. The striker 54 is pivotally supported on the box body 11 by the shafts 55 and 56 extending in the left-right direction. The first spring 57 urges the striker 54 in the urging pivoting direction in which the lid 30 is forced upward. The recess 51 is open toward the striker 54.

The indication mode changer 70 includes the conversion transmitter 82 arranged on the striker 54. The conversion transmitter 82 converts pivot movement of the striker 54 about the shafts 55 and 56 to linear movement of the first moving member 74 in the left-right direction.

Thus, the pivoting of the conversion transmitter 82 moves the first moving member 74 in the left-right direction.

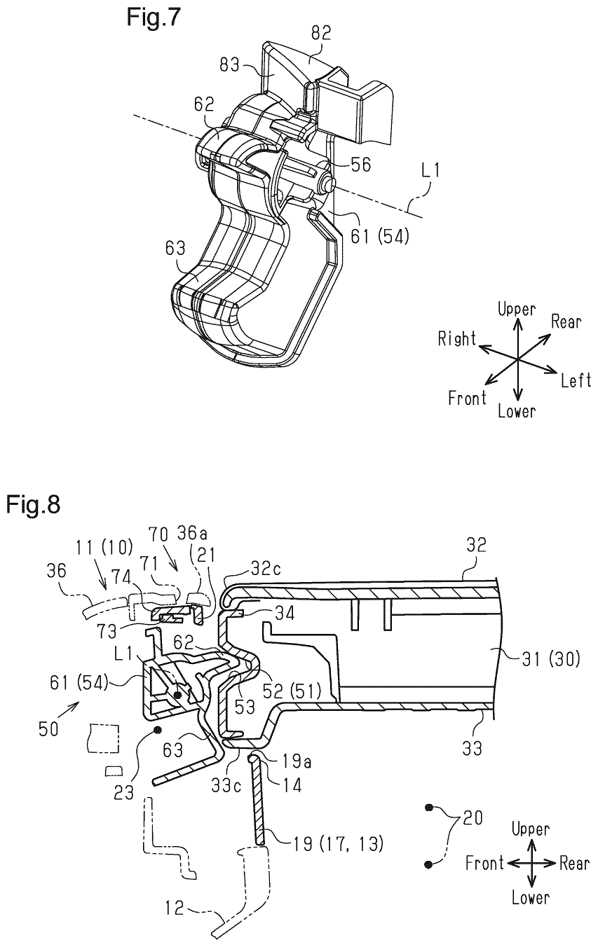

(1-6) As shown in FIGS. 7 and 10, the conversion transmitter 82 includes the inclined surface 83 inclined from the axis L1 of the shafts 55 and 56. The inclined surface 83 contacts the pressure-receiving portion 76 and applies rightward pressing force to the first moving member 74.

Thus, as the striker 54 pivots, the contact position of the inclined surface 83 with the pressure-receiving portion 76 changes. This moves the first moving member 74 in the left-right direction.

(1-7) As shown in FIG. 2, the indication mode changers 70 are located on the panel 36 at opposite sides of the upper opening 14 in the front-rear direction. Thus, when seeing any of the portion of the panel 36 adjacent to the front part of the lid 30 and the portion of the panel 36 adjacent to the rear part of the lid 30, the occupant may recognize whether the lid 30 is engaged with the box body 11 or not.

### Second Embodiment

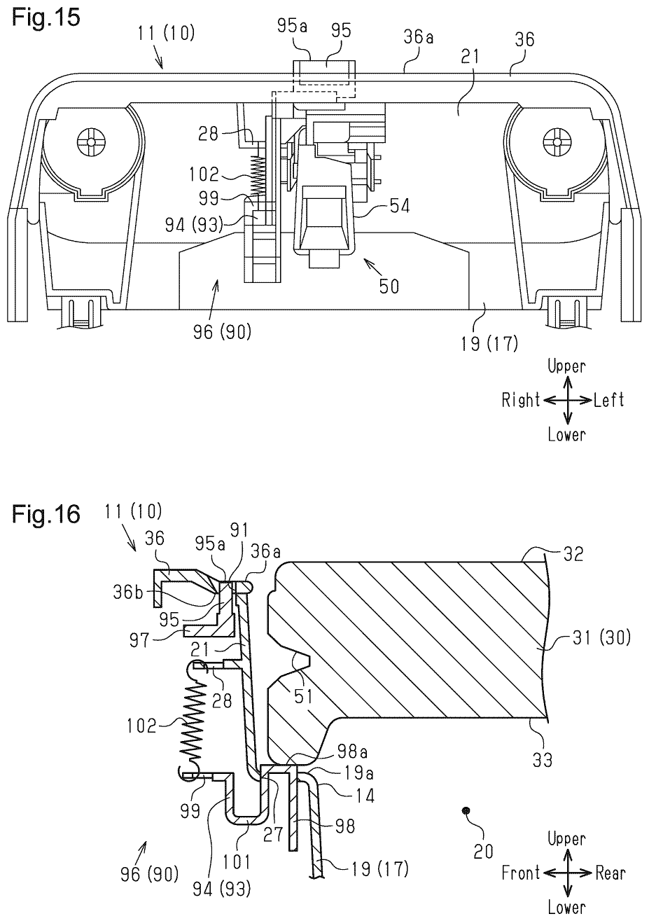

A vehicle interior component according to the present disclosure is embodied in a console box. A second embodiment of the console box will now be described with reference to FIGS. 15 to 18.

As shown in FIGS. 16 and 18, in the second embodiment, a window 91 is formed in an upper portion of the panel 36. The window 91 corresponds to a through window. The window 91 is formed at the same position as the window 71 of the first embodiment. In the same manner as the first embodiment, the window 91 is a hole extending through the panel 36 in the thickness-wise direction, or the vertical direction. The window 91 is a part of an indication mode changer 90 of the second embodiment.

An insertion hole 27 extends through an upper end of the second wall 19 in the vertical direction. The insertion hole 27 is formed in a portion of the upper end of the second wall 19 located inward from the support wall 21 in the front-rear direction. The insertion hole 27 is located at one side (left side) of the striker receptacle 23 in the left-right direction.

As shown in FIGS. 15 and 16, the indication mode changer 90 includes a second moving member 93. The second moving member 93 is coupled to the support wall 21 and is movable in the vertical direction.

The second moving member 93 includes a base 94 forming the framework of the second moving member 93. The base 94 is located outward from the support wall 21 in the front-rear direction.

The second moving member 93 includes an indication projection 95 projecting upward from the upper end of the base 94. The indication projection 95 is configured to be inserted through the window 91 in the vertical direction.

The indication mode changer 90 includes a shifting mechanism 96 configured to shift the second moving member 93 in the vertical direction so that the indication projection 95 is moved between an outer position that is shown in FIGS. 15, 17, and 18 and an inner position that is shown in FIG. 16.

The indication projection 95 includes a distal end surface, defining an upper end surface 95a. In the outer position, the upper end surface 95a is located at an outer side (upper side) of the ornamental surface 36a, which is located on the upper part of the panel 36. In the inner position, the upper end surface 95a is located at an inner side (lower side) as compared to in the outer position. In the second embodiment, in the inner position, the upper end surface 95a and the ornamental surface 36a are set to be located at substantially the same height.

As shown in FIGS. 16 and 18, the shifting mechanism 96 includes a stopper 97, a depression-receiving portion 98, a lower spring hook 99, and a joint plate 101 that are formed on the second moving member 93, an upper spring hook 28 that is formed on formed on the support wall 21, and a second spring 102.

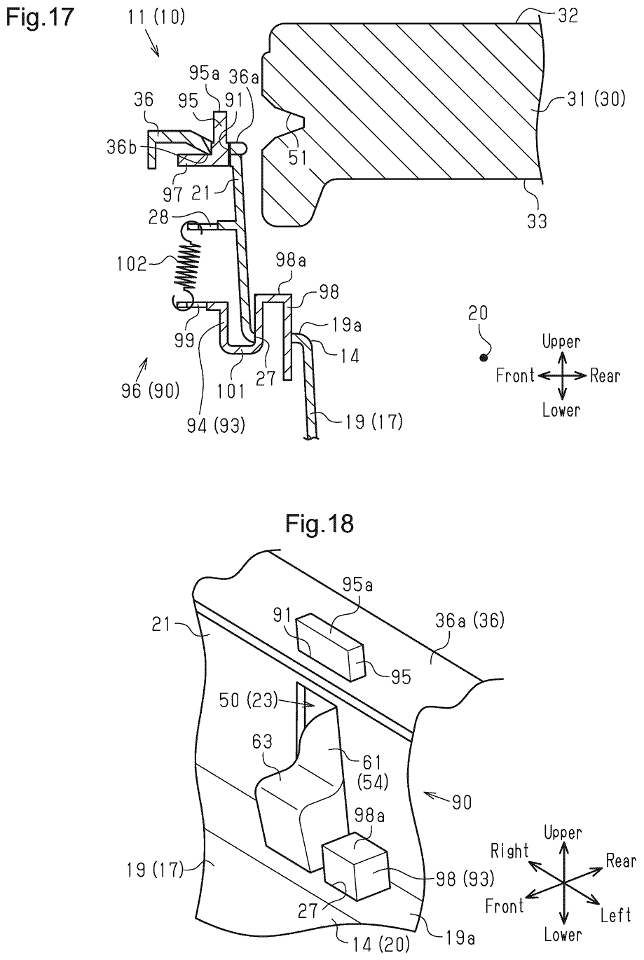

The stopper 97 projects from the upper end of the base 94 outward in the front-rear direction. The stopper 97 moves together with the second moving member 93 in the vertical direction. When the indication projection 95 is located in the outer position (FIG. 17), the stopper 97 is in contact with an inner surface (lower surface 36b) of the panel 36. When the indication projection 95 is located in the inner position (FIG. 16), the stopper 97 is located between the lower surface 36b and the upper spring hook 28.

The depression-receiving portion 98 is located at an inner side of the lower end of the base 94 in the front-rear direction. The depression-receiving portion 98 is located at an inner side of the support walls 21 in the front-rear direction. The joint plate 101 joins the lower end of the base 94 to the lower end of the depression-receiving portion 98. The joint plate 101 is located below the support wall 21. The depression-receiving portion 98 is configured to be inserted through the insertion hole 27 in the vertical direction.

The depression-receiving portion 98 includes an upper end surface 98a. The second wall 19 includes an upper end surface 19a. When the indication projection 95 is located in the outer position (FIG. 17), the upper end surface 98a is prominently extended upward from the upper end surface 19a of the second wall 19. The upper end surface 98a is located at this position when the lid 30 is disengaged from the box body 11.

When the indication projection 95 is located in the inner position (FIG. 16), the upper end surface 98a is located at a lower position than when the indication projection 95 is located in the outer position. In the second embodiment, the upper end surface 98a is located at substantially the same height as, or slightly higher than, and the upper end surface 19a. The upper end surface 98a is located at this position when the lid 30 is engaged with the box body 11.

The upper spring hook 28 projects outward from the support wall 21 in the front-rear direction. The lower spring hook 99 projects outward in the front-rear direction from the base 94 at a position lower than the upper spring hook 28.

The second spring 102 corresponds to a second urging member that urges the second moving member 93 from the inner position toward the outer position. The second spring 102 is tensioned in the vertical direction and is located between the upper spring hook 28 and the lower spring hook 99. The second spring 102 includes an upper end hooked on the upper spring hook 28. The second spring 102 includes a lower end hooked on the lower spring hook 99. The second spring 102 constantly applies upward urging force (pulling force) to the second moving member 93.

The structures of the second embodiment excluding those described above are the same as those of the first embodiment. Thus, same reference numerals are given to those components that are the same as the corresponding components of the first embodiment.

Such components will not be described in detail.

### Operation of Second Embodiment

Lid 30 Engaged with Box Body 11

When the lid 30 is engaged with the box body 11, as shown in FIG. 16. in the indication mode changer 90, the depression-receiving portion 98 is forced downward by the lid 30 against the urging force (pulling force) of the second spring 102. The upper end surface 98a of the depression-receiving portion 98 is located at substantially the same height as, or slightly higher than, the upper end surface 19a of the second wall 19. The indication projection 95, which is connected to the depression-receiving portion 98 by the joint plate 101 and the base 94, is located in the inner position. In the inner position, the upper end surface 95a of the indication projection 95 is located at an inner side (lower side) as compared to in the outer position (FIG. 17). In the second embodiment, the upper end surface 95a is located at substantially the same height as the ornamental surface 36a. When an occupant sees the console box 10, the occupant cannot see the indication projection 95 projected from the window 91 and instead can see the upper end surface 95a of the indication projection 95, which is retracted in the window 91.

The indication mode of the indication projection 95, which is changed by the indication mode changer 90, differs from that when the lid 30 is disengaged from the box body 11 (FIG. 17).

The indication mode of the indication projection 95, which is changed by the indication mode changer 90, allows the occupant to recognize that the lid 30 is engaged with the box body 11 and the lock mechanism 40 locks the lid 30 to a state in which the lid 30 is engaged with the box body 11.

Lid 30 Disengaged from Box Body 11

The state in which the lid 30 is disengaged from the box body 11 results from, for example, when the lid 30 is engaged with the box body 11 and the depressing operation is performed on one of the operating portions 41. The lid 30 is inclined upward in the left-right direction toward the operated one of the operating portions 41.

In this state, in the indication mode changer 90, as shown in FIG. 17, at least the portion of the lid 30 opposed to the depression-receiving portion 98 in the vertical direction is located at a higher position than when the lid 30 is engaged with the box body 11. Hence, depressing force is not applied from the lid 30 to the depression-receiving portion 98. The second moving member 93 is pulled upward by urging force (pulling force) of the second spring 102, and the stopper 97 is in contact with the lower surface 36b of the panel 36.

The upper end surface 98a of the depression-receiving portion 98 is prominently extended upward from the upper end surface 19a of the second wall 19.

The indication projection 95 is located in the outer position as shown in FIG. 17. In the outer position, a large part of the indication projection 95 projects upward from the window 91. The upper end surface 95a of the indication projection 95 is prominently extended upward from the ornamental surface 36a of the panel 36.

When an occupant sees the console box 10, the occupant can see the indication projection 95 prominently projecting from the window 91. The indication mode of the indication projection 95, which is changed by the indication mode changer 90, differs from that when the lid 30 is engaged with the box body 11 (FIG. 16).

The indication mode of the indication projection 95, which is changed by the indication mode changer 90, allows the occupant to recognize that the lid 30 is disengaged from the box body 11 and that the lid 30 is not locked by the lock mechanism 40 to a state in which the lid 30 is engaged with the box body 11.

In the same manner as the first embodiment, this allows the occupant to notice that if the lid 30 receives a load from the environment, the lid 30 may be separated from the box body 11. Also, the occupant may notice that the lid 30 can be locked to the box body 11 by engaging the lid 30 with the box body 11.

Referring to FIG. 17, when engaging the lid 30 with the box body 11, a downward force is applied to the lid 30. During engagement of the lid 30 with the box body 11, the lower surface of the lid 30 comes into contact with the upper end surface 98a of the depression-receiving portion 98. Then, when the lid 30 is further moved downward, the depression-receiving portion 98 receives a depressing force from the lid 30. The depression-receiving portion 98 is depressed by the lid 30 against the urging force (pulling force) of the second spring 102. This downwardly moves the indication projection 95, which is connected to the depression-receiving portion 98 by the joint plate 101 and the base 94.

When the lid 30 is engaged with the box body 11, as shown in FIG. 16, the upper end surface 98a of the depression-receiving portion 98 is located at substantially the same height as, or slightly higher than, the upper end surface 19a of the second wall 19. The indication projection 95 is located in the inner position. In the inner position, the upper end surface 95a of the indication projection 95 and the ornamental surface 36a are located at substantially the same height. When an occupant sees the console box 10, the occupant cannot see the indication projection 95 projected from the window 91 but instead can see the upper end surface 95a of the indication projection 95, which is retracted in the window 91.

### Advantages of Second Embodiment

The console box 10 of the second embodiment includes the indication mode changer 90 having the indication mode that changes between when the lid 30 is engaged with the box body 11 and when the lid 30 is disengaged from the box body 11. Therefore, the second embodiment obtains the advantage (1-1) described above.

The second embodiment further obtains the following advantages.

(2-1) The indication mode changer 90 includes the second moving member 93 including the indication projection 95 and the shifting mechanism 96 configured to move the second moving member 93 in the thickness-wise direction (vertical direction) so that the indication projection 95 moves between the outer position and the inner position. As shown in FIG. 16, when the lid 30 is engaged with the box body 11, the shifting mechanism 96 positions the indication projection 95 in the inner position. As shown in FIG. 17, when the lid 30 is disengaged from the box body 11, the shifting mechanism 96 positions the indication projection 95 in the outer position.

With this configuration, the indication mode changer 90 changes the position of the indication projection 95 between when the lid 30 is engaged with the box body 11 and when the lid 30 is disengaged from the box body 11. By seeing the outer side (upper side) of the window 91, that is, seeing the projection state of the indication projection 95 from the window 91, an occupant of the vehicle may recognize whether the lid 30 is engaged with the box body 11 or not.

(2-2) The indication mode changer 90 includes the second spring 102 urging the second moving member 93 in a direction from the inner position toward the outer position. The second moving member 93 includes the depression-receiving portion 98 projecting into the box body 11. In other words, the depression-receiving portion 98 projects into the accommodation portion 20 and is opposed to the lid 30. During engagement of the lid 30 with the box body 11, the second moving member 93 is forced downward by the lid 30 via the depression-receiving portion 98 against the urging force of the second spring 102. As a result, the indication projection 95 is moved to the inner position.

Thus, during engagement of the lid 30 with the box body 11, the downward movement of the lid 30 is applied to move the second moving member 93 downward. This eliminates the need for a separate mechanism that generates force for moving the second moving member 93.

### Third Embodiment

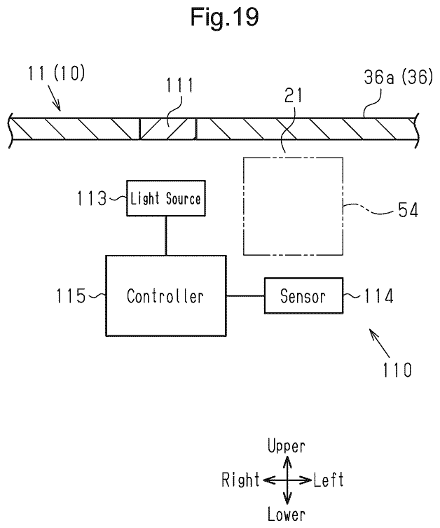

A vehicle interior component according to the present disclosure is embodied in a console box. A third embodiment of the console box will now be described with reference to FIG. 19.

A third embodiment of an indication mode changer 110 includes a window 111 arranged on an upper portion of the panel 36. The window 111 corresponds to a light-transmissive window. The window 111 is formed at the same position as the window 71 of the first embodiment. The window 111 is formed from a transparent or translucent resin material. The window 71 is transmissive to visible light. At least a part of the upper portion of the panel 36 surrounding the window 111 is formed from a colored resin material. The surrounding part may be formed from, for example, a colored resin material in which a coloring agent such as a pigment is mixed with a resin material. The entire upper portion of the panel 36 excluding the window 111 may be formed from the colored resin material.

The indication mode changer 110 includes a light source 113 arranged at an inner side (lower side) of the window 111. The light source 113 emits visible light toward the window 111. The light source 113 may be, for example, a semiconductor element such as a light emitting diode (LED).

The indication mode changer 110 includes a sensor 114 and a controller 115. The sensor 114 is, for example, installed on the console box 10 or a component arranged around the console box 10. The sensor 114 detects an engagement state of the lid 30 to the box body 11, for example, an engaged state and a disengaged state. The controller 115 changes an emission mode of visible light from the light source 113 between when the sensor 114 detects the engaged state of the lid 30 and when the sensor 114 detects the disengaged state of the lid 30. For example, the controller 115 may switch the light source 113 off when the sensor 114 detects the engaged state of the lid 30, and switch the light source 113 on when the sensor 114 detects that the disengaged state of the lid 30. Alternatively, the controller 115 may switch the light source 113 on when the sensor 114 detects the engaged state of the lid 30, and repeatedly switch the light source 113 on and off when the sensor 114 detects the disengaged state of the lid 30. The controller 115 may change the color of light emitted from the light source 113 between when the sensor 114 detects the engaged state of the lid 30 and when the sensor 114 detects the disengaged state of the lid 30.

The controller 115 may be processing circuitry including: (1) one or more processors that operate according to a computer program (software); (2) one or more dedicated hardware circuits (application specific integrated circuits: ASIC) that execute at least part of various processes, or (3) a combination of these. The processor includes a CPU and memory such as RAM and ROM. The memory stores program codes or instructions configured to cause the CPU to execute processes. The memory, or a non-transitory computer readable media, include any type of media that are accessible by general-purpose computers and dedicated computers.

### Operation of Third Embodiment

In the indication mode changer 110, the emission mode of visible light from the light source 113 differs between when the lid 30 is engaged with the box body 11 and when the lid 30 is disengaged from the box body 11. Thus, when an occupant sees the window 111, the appearance of the window 111 differs when the lid 30 is engaged with the box body 11 and when the lid 30 is disengaged from the box body 11.

Even when the engagement state of the lid 30 to the box body 11 is changed, the shape of the console box 10 remains the same at an outer side (upper side) of the window 111. Only the emission mode of visible light from the light source 113 at an inner side (lower side) of the window 111 changes.

### Advantage of Third Embodiment

The console box 10 of the third embodiment includes the indication mode changer 110 having the indication mode that changes between when the lid 30 is engaged with the box body 11 and when the lid 30 is disengaged from the box body 11. Therefore, the third embodiment obtains the advantage (1-1) described above.

In the console box 10 of the third embodiment, the indication mode changer 110 uses a member (light source 113) arranged at an inner side (lower side) of the window 111, which transmits visible light, to change the indication mode of the window 111 in the same manner as the first embodiment. Therefore, the third embodiment obtains the advantage (1-2) described above.

The third embodiment further obtains the following advantages.

(3-1) The indication mode changer 110 includes the window 111 arranged on the box body 11 to transmit visible light and the light source 113 arranged at an inner side (lower side) of the window 111 to emit visible light toward the window 111. The indication mode changer 110 changes the emission mode of visible light from the light source 113 between when the lid 30 is engaged with the box body 11 and when the lid 30 is disengaged from the box body 11, thereby changing the indication mode of the window 111.

By seeing the indication mode of the window 111, which is changed by the indication mode changer 110, for example, the indication mode of the window 111 corresponding to the illumination state (intermittent illumination state) of the light source 113 or the indication mode of the window 111 corresponding to the color of light emitted from the light source 113, the occupant may recognize whether the lid 30 is engaged with the box body 11 or not.

### Modified Examples

The above embodiments may be modified as described below. The embodiment and the following modified examples can be combined as long as the combined modified examples remain technically consistent with each other.

### Modifications of Windows 71 and 111

In the first embodiment, the window 71 may be formed from a material that is transmissive to visible light, for example, a transparent or translucent resin material in the same manner as the third embodiment.

In the third embodiment, the window 111 may be defined by a hole in the same manner as the first embodiment.

### Modifications of Pivot Shaft 35

The two pivot shafts 35 may arranged to extend in the left-right direction.

One of the two pivot shafts 35 may be omitted. In this case, the lock mechanism 40 corresponding to the omitted pivot shaft 35 is also omitted.

### Modifications of Upthrust Mechanism 50

The two upthrust mechanisms 50 may be arranged at opposite sides of the support 13 in the left-right direction instead of being arranged at opposite sides of the support 13 in the front-rear direction.

The number of the upthrust mechanisms 50 may be changed.

The first spring 57, which urges the striker 54 in the urging pivoting direction to upwardly force the lid 30, may be a spring differing in type from the torsion spring. The spring 81 and the second spring 102 may be a spring differing in type from the extension coil spring.

The first urging member, which urges the striker 54 in the urging pivoting direction to upwardly force the lid 30, may be an urging member differing from a spring and may be, for example, an elastic body. The second urging member may be an urging member differing from a spring and may be, for example, an elastic body.

The second upthrust portion 63 may be omitted from the striker 54.

### Modifications of Indication Mode Changer

In the first embodiment, the first moving member may be configured to pivot about a shaft extending in the longitudinal direction of the first moving member. In this case, the first indicator and the second indicator are arranged on a peripheral surface of the first moving member. The first indicator and the second indicator are arranged next to each other in the circumferential direction of the first moving member. The first moving member pivots about the shaft of the first moving member. The pivot movement moves the first moving member in an intersecting direction that intersects the thickness-wise direction at an inner side of the window 71. That is, the intersecting direction includes the circumferential direction of the first moving member. The first moving member moves so that one of the first indicator and the second indicator located inside the window 71 when the lid 30 is engaged with the box body 11 differs from the other one of the first indicator and the second indicator located inside the window 71 when the lid 30 is disengaged from the box body 11. This configuration also obtains the same advantage as the first embodiment.

The indication mode changers 70, 90, and 110 may be arranged on only one side of the support 13 in the front-rear direction.

In the first embodiment, the first indicator 78 and the second indicator 79 may differ from each other in only color, only pattern, or both color and pattern.

The second indicator 79 may be adhesive tape that differs in color from the first indicator 78.

In the second embodiment, when the indication projection 95 is located in the inner position, the upper end surface 95a of the indication projection 95 may be arranged at a higher position than the ornamental surface 36a. In other words, when the indication projection 95 is located in the inner position, the upper end of the indication projection 95 including the upper end surface 95a may project upward from the window 91.

In the second embodiment, the shifting mechanism 96 may position the indication projection 95 in the outer position when the lid 30 is engaged with the box body 11. In this case, the shifting mechanism 96 positions the indication projection 95 in the inner position when the lid 30 is disengaged from the box body 11.

### OTHER MODIFICATIONS

The vehicle interior component according to the present disclosure may be applied to a vehicle interior component other than a console box as long as the vehicle interior component includes a box body, a lid, and a lock mechanism.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle interior component, comprising:
a box body including an accommodation portion having an opening;
a lid movably coupled to the box body, the lid being configured to close the opening by engaging with the box body;
a lock mechanism configured to lock the lid to a state in which the lid is engaged with the box body and unlock the lid in accordance with an unlocking operation; and
an indication mode changer configured to change an indication mode of the indication mode changer between when the lid is engaged with the box body and when the lid is disengaged from the box body.

2. The vehicle interior component according to claim 1, wherein
the indication mode changer includes a light-transmissive window that is arranged on the box body and is transmissive to visible light,
a side of the box body including an ornamental surface defines an outer side, and a side of the box body opposite to the ornamental surface defines an inner side, and
the indication mode changer is configured to change an indication mode of the light-transmissive window using a member arranged at the inner side of the ornamental surface.

3. The vehicle interior component according to claim 2, wherein
the indication mode changer includes a light source arranged at the inner side of the light-transmissive window and configured to emit visible light toward the light-transmissive window, and
the indication mode changer is configured to change an emission mode of the visible light from the light source between when the lid is engaged with the box body and when the lid is disengaged from the box body, thereby changing the indication mode of the light-transmissive window.

4. The vehicle interior component according to claim 2, wherein
the indication mode changer includes a first moving member arranged at the inner side of the light-transmissive window to be movable in an intersecting direction that intersects a thickness-wise direction of the box body,
the first moving member includes an outer surface including a first indicator and a second indicator that differ from each other in at least one of color and pattern,
the first indicator and the second indicator are arranged next to each other in the intersecting direction, and
the indication mode changer is configured to move the first moving member so that one of the first indicator and the second indicator located inside the light-transmissive window when the lid is engaged with the box body differs from the other one of the first indicator and the second indicator located inside the light-transmissive window when the lid is disengaged from the box body.

5. The vehicle interior component according to claim 4, further comprising:
an upthrust mechanism configured to force the lid upward from the box body in accordance with the unlocking operation of the lid,
wherein the indication mode changer is configured to move the first moving member in the intersecting direction by applying an action of the upthrust mechanism upwardly forcing the lid.

6. The vehicle interior component according to claim 5, wherein
the upthrust mechanism includes
a striker including a shaft extending in the intersecting direction and an upthrust portion, the striker being pivotally supported by the shaft on the box body,
a first urging member configured to urge the striker in an urging pivoting direction in which the lid is forced upward, and
a recess arranged in a peripheral surface of the lid, the recess being open toward the striker and including a wall surface defining a pushed-up portion,
the upthrust portion is received in the recess and applies upthrust force to the pushed-up portion of the recess when the lid is engaged with the box body,
the upthrust portion is configured to withdraw from the recess when the lid is unlocked and the lid is forced by the upthrust mechanism upward from the box body,
the indication mode changer includes a conversion transmitter arranged on the striker, and
the conversion transmitter is configured to convert pivot movement of the striker about the shaft into linear movement of the first moving member in the intersecting direction.

7. The vehicle interior component according to claim 6, wherein
the conversion transmitter includes an inclined surface inclined from an axis of the shaft, the inclined surface being in contact with the first moving member, and
the inclined surface is configured to apply pressing force in the intersecting direction to the first moving member as the striker pivots.

8. The vehicle interior component according to claim 1, wherein
the indication mode changer includes a through window extending through the box body in the thickness-wise direction,
a side of the box body including an ornamental surface defines an outer side, and a side of the box body opposite to the ornamental surface defines an inner side,
the indication mode changer includes a second moving member including an indication projection,
when a distal end surface of the indication projection is located at the outer side of the ornamental surface, the indication projection is located in an outer position,
when the distal end surface of the indication projection is located inward as compared to when the distal end surface of the indication projection is located in the outer position, the indication projection is located in an inner position,
the indication mode changer includes a shifting mechanism configured to shift the second moving member so that the indication projection shifts between the outer position and the inner position, and
the shifting mechanism is configured to position the indication projection in one of the outer position and the inner position when the lid is engaged with the box body, and in the other one of the outer position and the inner position when the lid is disengaged from the box body.

9. The vehicle interior component according to claim 8, wherein
the shifting mechanism is configured to position the indication projection in the inner position when the lid is engaged with the box body, and position the indication projection in the outer position when the lid is disengaged from the box body,
the indication mode changer includes a second urging member configured to urge the second moving member so that the indication projection moves from the inner position toward the outer position,
the second moving member includes a depression-receiving portion projecting into the box body, and
the second moving member is configured to be forced downward by the lid via the depression-receiving portion against urging force of the second urging member, thereby moving the indication projection to the inner position, during engagement of the lid with the box body.
